(19) United States
(12) Patent Application Publication
(10) Pub. No.: US 2017/0278302 A1
(43) Pub. Date: Sep. 28, 2017

(54) METHOD AND DEVICE FOR REGISTERING AN IMAGE TO A MODEL

(71) Applicant: THOMSON LICENSING, Issy les Moulineaux (FR)

(72) Inventors: Kiran VARANASI, SAARBRUECKEN (DE); Praveer SINGH, FARIDABAD (IN); Pierrick JOUET, RENNES (FR)

(21) Appl. No.: 15/505,644

(22) PCT Filed: Aug. 24, 2015
(86) PCT No.: PCT/EP2015/069308

§ 371 Date: Feb. 22, 2017

(30) Foreign Application Priority Data
Aug. 29, 2014 (EP) 14306333.7
Jun. 10, 2015 (EP) 15305884.7

(51) Int. Cl. G06T 17/20; G06T 7/33; G06T 19/20

(52) U.S. Cl. CPC G06T 17/20; G06T 19/20; G06T 7/33; G06T 2207/30201; G06T 2219/2004

(57) ABSTRACT

A method of registering an image to a model, comprising: providing a 3D facial model, said 3D facial model being parameterized from a plurality of facial expressions in images of a reference person to obtain a plurality of sparse and spatially localized deformation components; tracking a set of facial landmarks in a sequence of facial images of a target person to provide sets of feature points defining sparse facial landmarks; computing, a set of localized affine transformations connecting a set of facial regions of the said 3D facial model to the sets of feature points defining the sparse facial landmarks; and applying the localized affine transformations to the 3D facial model and registering the sequence of facial images with the transformed 3D facial model.

### TECHNICAL FIELD

The present invention relates to a method and device for registering an image to a model. Particularly, but not exclusively, the invention relates to a method and device for registering a facial image to a 3D mesh model. The invention finds applications in the field of 3D face tracking and 3D face video editing.

### BACKGROUND

Faces are important subjects in captured images and videos. With digital imaging technologies, a person's face may be captured a vast number of times in various contexts. Mechanisms for registering different images and videos to a common 3D geometric model, can lead to several interesting applications. For example, semantically rich video editing applications can be developed, such as changing the facial expression of the person in a given image or even making the person appear younger. However, for in order to realize any such applications, firstly, a 3D face registration algorithm is required that robustly estimates a registered 3D mesh in correspondence to an input image.

Currently, there are various computer vision algorithms that try to address this problem. They fall into two categories: (1) methods that require complex capture setups, such as controlled lighting, depth cameras or calibrated cameras (2) methods that work with single monocular videos. Methods in the second category can be further sub-divided into performance capture methods that produce a dense 3D mesh as output for a given input image or video, but which are algorithmically complex and computationally expensive robust facial landmark detection methods that are computationally fast, but only produce a sparse set of facial landmark points, such as the locations of the eyes and the tip of the nose.

Moreover, existing methods for facial performance capture require a robust initialization step where they rely on a database of 3D faces with enough variation, such that a given input image of a person can be robustly fitted to a data-point in the space spanned by the database of faces. However, this 3D face database is not often available, and typically not large enough to accommodate all variations in human faces. Further, this fitting step adds to the computational cost of the method.

The present invention has been devised with the foregoing in mind.

### SUMMARY

A general aspect of the invention provides a method for computing localized affine transformations between different 3D face models by assigning a sparse set of manual point correspondences.

A first aspect of the invention concerns a method of registering an image to a model, comprising:

providing a 3D facial model, said 3D facial model being parameterized from a plurality of facial expressions in images of a reference person to obtain a plurality of sparse and spatially localized deformation components;

tracking a set of facial landmarks in a sequence of facial images of a target person to provide sets of feature points defining sparse facial landmarks;

computing, a set of localized affine transformations connecting a set of facial regions of the said 3D facial model to the sets of feature points defining the sparse facial landmarks; and

applying the localized affine transformations to the 3D facial model and

registering the sequence of facial images with the transformed 3D facial model.

In an embodiment, the 3D facial model is a blendshape model.

In an embodiment, the method includes aligning and projecting dense 3D face points onto the appropriate face regions in an input face image.

A further aspect of the invention relates to a device for registering an image to a model, the device comprising memory and at least one processor in communication with the memory, the memory including instructions that when executed by the processor cause the device to perform operations including:

tracking a set of facial landmarks in a sequence of facial images of a target person to provide sets of feature points defining sparse facial landmarks;

computing, a set of localized affine transformations connecting a set of facial regions of the said 3D facial model to the sets of feature points defining sparse facial landmarks; and

applying the localized affine transformations and

registering the sequence of facial images with the 3D facial model

A further aspect of the invention provides a method of providing a 3D facial model from at least one facial image, the method comprising:

providing a 3D facial blendshape model, said 3D facial blendshape model being parameterized from facial expressions in corresponding reference images of a reference person to provide a plurality of localized deformation components;

receiving an input image of a first person;

computing, using the 3D facial blendshape model, a set of localized affine transformations connecting a set of facial regions of the said 3D facial blendshape model to the corresponding regions of the input image of the first person; and

tracking a set of facial landmarks in a sequence of images of the first person; and

applying the 3D facial blendshape model to regularize the tracked set of facial landmarks to provide a 3D motion field.

An embodiment of the invention provides a method for correcting for variations in facial physiology and producing the 3D facial expressions in the face model as how they appear in an input face video.

An embodiment of the invention provides a method for aligning and projecting dense 3D face points onto the appropriate face regions in an input face image.

Some processes implemented by elements of the invention may be computer implemented. Accordingly, such elements may take the form of an entirely hardware embodiment, an entirely software embodiment (including firmware, resident software, micro-code, etc.) or an embodiment combining software and hardware aspects that may all generally be referred to herein as a “circuit”, “module” or “system’. Furthermore, such elements may take the form of a computer program product embodied in any tangible medium of expression having computer usable program code embodied in the medium.

Since elements of the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 is a flow chart illustrating steps of method of registration of a model to an image in accordance with an embodiment of the invention.

FIG. 2 illustrates an example set of images depicting different facial expressions;

FIG. 3 illustrates an example of a 3D mesh output by a face tracker in accordance with an embodiment of the invention;

FIG. 4 illustrates an example of a blendshape model in accordance with an embodiment of the invention;

FIG. 5 illustrates examples of blendshape targets in accordance with an embodiment of the invention;

FIG. 6 illustrates the overlying of the mesh output of the face tracker over the 3D model in accordance with an embodiment of the invention;

FIG. 7 illustrates correspondences between points of a 3D model and feature points of a face tracker output according to an embodiment of the invention;

FIG. 8 illustrates division of the face of FIG. 7 into different facial regions for localized mapping between the face tracker output and the 3D model according to an embodiment of the invention

FIG. 9 illustrates examples of the output of face tracking showing an example of a sparse set of features;

FIG. 10 illustrates examples of dense mesh registration in accordance with embodiments of the invention; and

FIG. 11 illustrates functional elements of an image processing device in which one or more embodiments of the invention may be implemented.

### DETAILED DESCRIPTION

In a general embodiment the invention involves inputting a monocular face video comprising a sequence of captured images of a face and tracking facial landmarks (for example the tip of the nose, corners of the lips, eyes etc.) in the video. The sequence of captured images typically depict a range of facial expressions over time including, for example, facial expressions of anger, surprise, laughing, talking, smiling, winking, raised eyebrow(s) as well as neutral facial expressions. A sparse spatial feature tracking algorithm, for example, may be applied for the tracking of the facial landmarks. The tracking of the facial landmarks produces camera projection matrices at each time-step (frame) as well as a sparse set of 3D points indicating the different facial landmarks.

The method includes applying a 3D mesh blendshape model of a human face that is parameterized to blend between different facial expressions (each of these facial expressions are called blendshape targets, a weighted linear blend between these targets produces an arbitrary facial expression). A method is then applied to register this 3D face blendshape model to the previous output of sparse facial landmarks, where the person in the input video may have very different physiological characteristics as compared to the mesh template model. In some embodiments of the invention in order to get a more robust, dense and accurate tracking a dense 3D mesh is employed for tracking. In other words a direct correspondence between a vertex in the 3D mesh to a particular pixel in the 2D image is provided

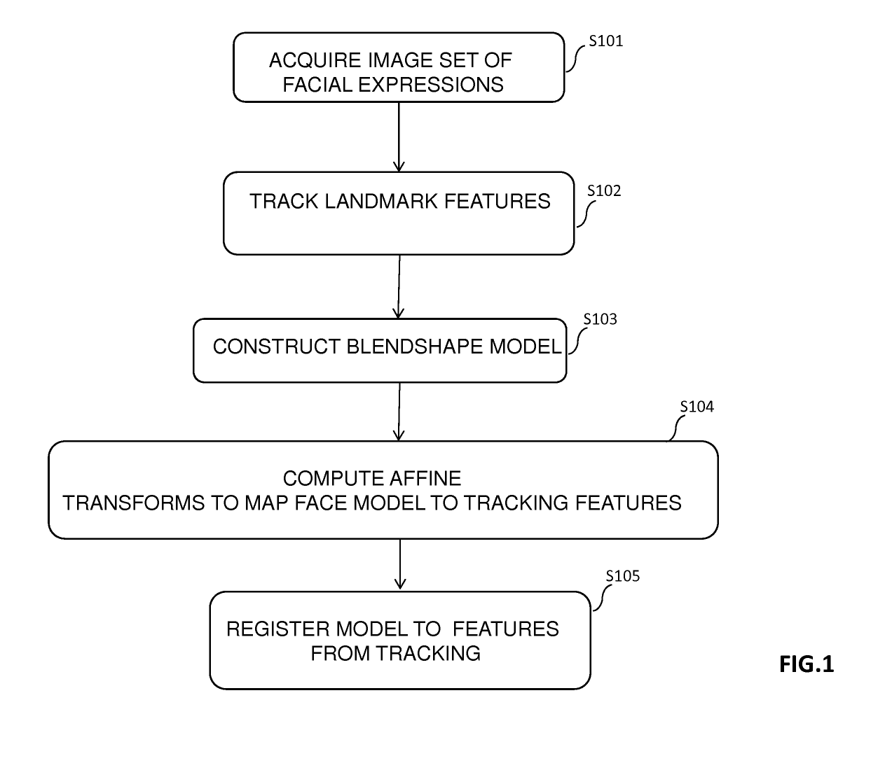

FIG. 1 is a flow chart illustrating steps of method of registration of a model to an image in accordance with a particular embodiment of the invention

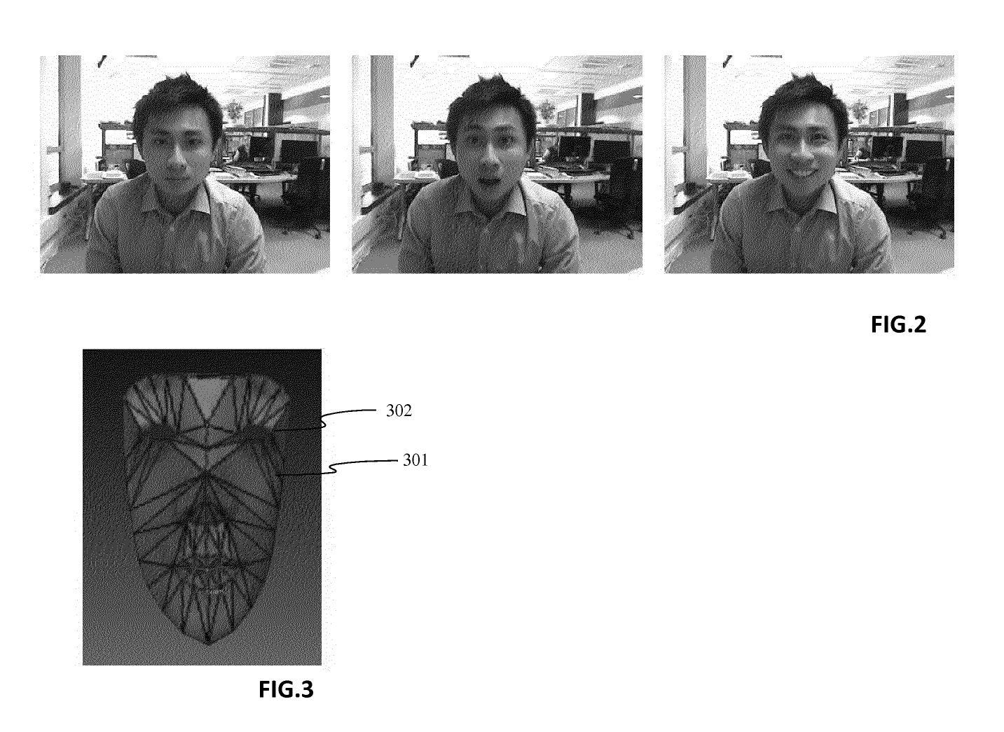

In step S101 a set of images of depicting facial expressions of a person is captured. In this step, a video capturing the different facial expressions of a person is recorded using a camera such as a webcam. This person is referred to herein as the reference person. The captured images may then be used to perform face tracking through the frames of the video so generated. In one particular example a webcam is placed at a distance of approximately 1-2 meters from the user. For example around 1 minute of video recording is done at a resolution of 640×480. The captured images depict all sorts of facial expressions of the reference person including for example Anger, Laughter, Normal Talk, Surprise, Smiling, Winking, Raising Eye Brows and Normal Face. During the capture of the images the reference person is asked to make minimum radial distortions such as extreme head movements or any out of plane rotation can cause the Face Tracker to lose track of the facial landmarks. An example of a set of captured images presenting different facial expressions is shown in FIG. 2.

In one particular embodiment of the invention the captured video file is converted to .avi format (using Media Converter software from ArcSoft) to be provided as input to a 2D landmark tracking algorithm.

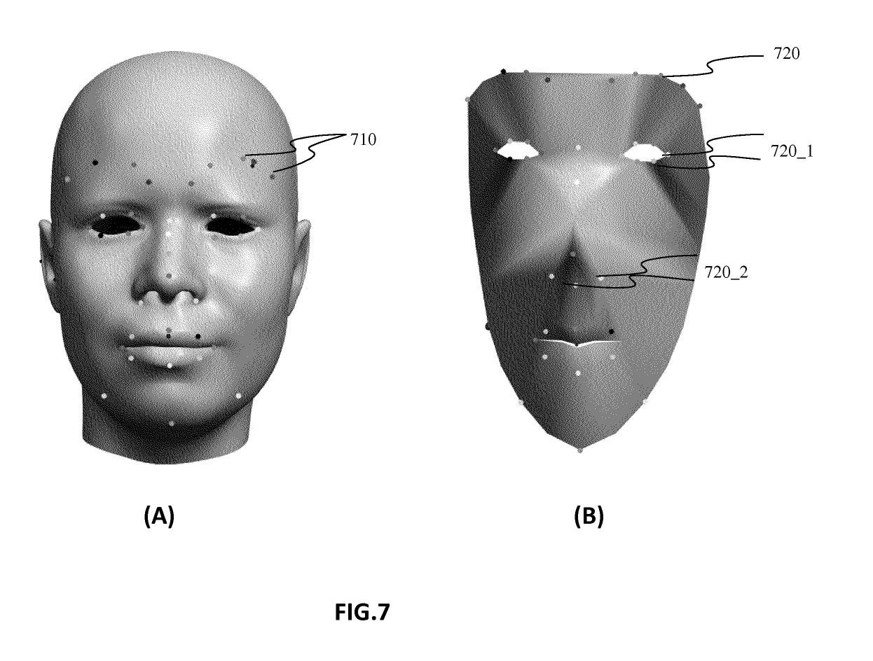

In step S102 2D facial landmark features are tracked through the sequence of images acquired in acquisition step S101. At each time-step (frame) the tracking produces camera projection matrices and a sparse set of 3D points, referred to as 3D reference landmark locations or facial feature points, defining the different facial landmarks (tip of the noise, corners of the lips, eyes etc.). An example of facial landmark points 720 is illustrated in the output of a face tracker as illustrated in FIG. 7B. For example, a first set of facial feature points 720_1 for example defines the outline of the left eye awhile a second set of facial feature points 720_2 defines the outline of the nose.

In one embodiment of the invention, the 2D landmark features are tracked using a sparse spatial feature tracking algorithm, for example Saragih's face tracker (“Face alignment through subspace constrained mean-shifts” J. Saragih, S. Lucey, J. Cohn IEEE International Conference on Computer Vision 2009. Alternatively, other techniques used in the computer vision such as dense optical flow, particle filters may be applied for facial landmark tracking. The Saragih tracking algorithm uses a sparse set of 66 points on the face including the eyes, nose, mouth, face boundary and the eye brows. The algorithm is based upon a Point Distribution model (PDM) linearly modeling the non-rigid shape variations around the 3D reference landmark locations Xᵢ, i=1, . . . , n, and then applies a global rigid transformation:

xᵢ=sPR(Xᵢ+φᵢq)+t (1)

where:

$$P = [ \begin{matrix}1 & 0 & 0 \\ 0 & 1 & 0\end{matrix} ]$$

is an orthogonal matrix,

xᵢ is the estimated 2D location of the i-th landmark and s, R, t and q are PDM parameters representing scaling, 3D Rotation, 2D translation and the non-rigid deformation parameters, φᵢ is the sub-matrix variation of the basis of variation to the i-th landmark. In a sense the Projection matrix is basically a 2×4 weak perspective projection which is similar to an orthographic projection with the only difference in terms of scaling with closer objects appearing bigger in the projection and vice-versa. Thus to simplify process equation (1) is represented as:

xᵢ=PXᵢ (2)

where:

$$P = [ \begin{matrix}{sP}^{x} & {sP}^{y} & {sP}^{z} & {t}_{x} \\ {sP}_{y}^{x} & {sP}_{y}^{y} & {sP}_{y}^{z} & {t}_{y} \\ 0 & 0 & 0 & 1\end{matrix} ]$$

which can also be written in the form:

$$P = [ \begin{matrix}sR & t \\ {0}^{T} & 1\end{matrix} ]$$

where s denotes the scaling, R the rotation matrix and t gives the translation. In order to compute the most likely landmark location a response map is computed using localized feature detectors around every landmark position which are trained to distinguish aligned and misaligned locations. After this a global prior is enforced on the combined location in an optimized way. Thus as an output from Saragih's Face Tracker a triangulated 3D point cloud is obtained, the 2×4 Projection Matrix and the corresponding images with the projected landmark points for every frame of the video. An example of a triangulated point cloud 301 and landmark points 302 from the face tracker is illustrated in FIG. 3

In step S103 a 3D blendshape model is obtained. In this step a 3D mesh model of a human face is parameterized to blend between different facial expressions.

A 3D model which can be easily modified by an artist through spatially localized direct manipulations is desirable. In one embodiment of the method, a 3D mesh model of a reference human face is used that is parameterized to blend between different facial expressions. Each of these facial expressions is referred to as a blendshape target. A weighted linear blend between the blendshape targets produces an arbitrary facial expression. Such a model can be built from sculpting the expressions manually or scanning the facial expressions of a single person. In principle, in other embodiments of the method, this model can be replaced by a statistical model containing expressions of several people (For example, “Face Warehouse: A 3D facial expression database for visual computing” IEEE Trans. on Visualization and Computer Graphics (20) 3 413-425, 2014) However these face databases are expensive and building them is a time-consuming effort. So instead, a simple blendshape model is used showing facial expressions of a single person.

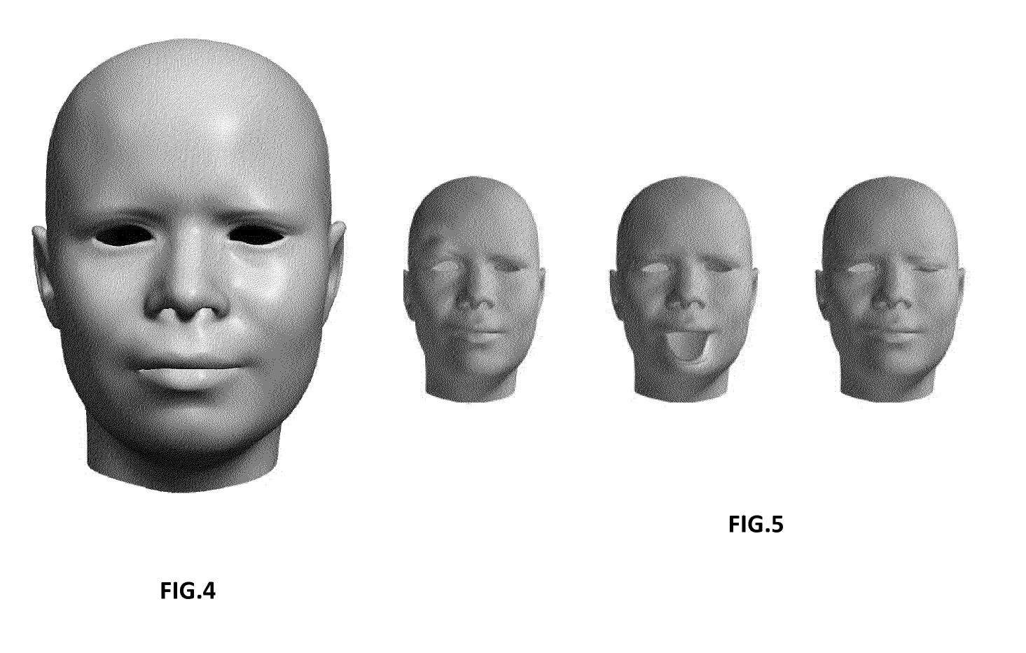

In order to obtain more spatially localized effects the 3D blendshape model is reparameterised into a plurality of Spare Localized Deformation Components (referred to from herein in as SPLOCS, published by Neumann et al. “Sparse localized deformation components” ACM Trans. Graphics. Proc. SIGGRAPH Asia 2013). FIG. 4 illustrates an example of a mean shape (corresponding to a neutral expression) of a 3D blendshape model as an output after re-parameterizing the shapes from a Facewarehouse database using SPLOCS. FIG. 5 illustrates an example of different blendshape targets out of 40 different components from the 3D blendshape model as an output after reparameterizing the shapes from Facewarehouse database using SPLOCS. The final generated blendshape model illustrated in FIG. 4 is basically a linear weighted sum of 40 different blendshape targets of FIG. 5 which typically represent sparse and spatially localized components or individual facial expressions (like an open mouth or a winking eye).

Formally, the face model is represented as a column vector F containing all the vertex coordinates in some arbitrary but fixed order as xyzxyz . . . xyz.

Similarly the k^{th} blendshape target can be represented by bₖ, and the blendshape model is given by:

$$F = {\sum }_{k} {w}_{k} {b}_{k} \qquad ( 3 )$$

Any weight wₖ basically defines the span of the blendshape target bₖ and when combined together they define the range of expressions over the modeled face F. All the blendshape targets can be placed as columns of a matrix B and the weights aligned in a single vector w, thus resulting in a blendshape model given as:

F=Bw (4)

Consequently a 3D face model F is obtained which after being subjected to some rigid and non-rigid transforms, can be registered on top of the sparse set of 3D facial landmarks previously obtained. Since the face model has very different facial proportions to the facial regions of the captured person, a novel method is proposed in which localized affine warps are estimated that map different facial regions between the model and the captured person. This division into facial regions helps to estimate a localized affine warp between the model and the face tracker output.

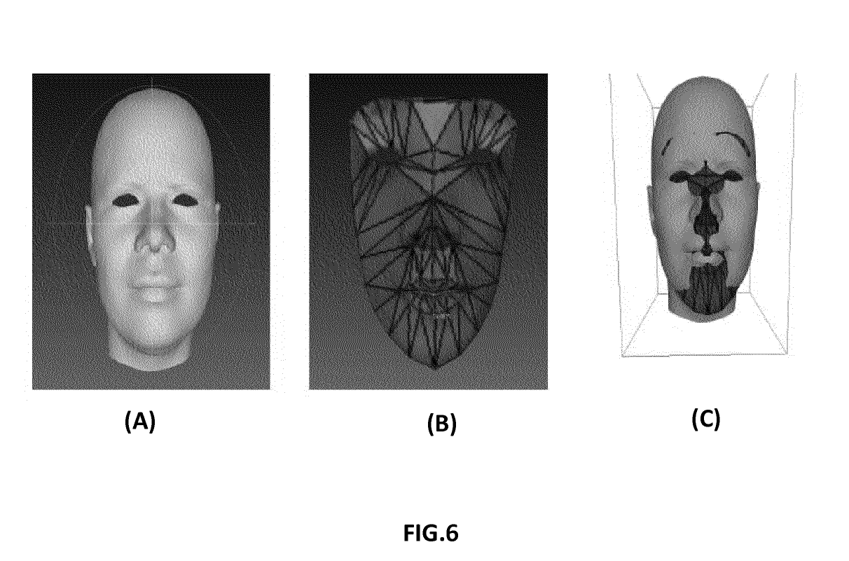

The rigid transform takes into account any form of scaling, rotation or translation. For the non-rigid transform, the Direct Manipulation technique by J. P. Lewis and Ken Anjyo (“Direct Manipulation Blendshapes” J. P. Lewis, K. Anjyo. IEEE Computer Graphics Applications 30 (4) 42-50, July, 2010) for example may be applied where for every frame in the video, the displacements for each of the 66 landmarks are computed in 3D from the mean position, and this is then applied to the corresponding points in the 3D face model according to the present embodiment to generate a resultant mesh for every frame. FIG. 6 illustrates an example of (A) a mean (neutral) shape of the 3D blendshape model, (B) a 3D mesh (triangulated point cloud) from the face tracker with a neutral expression; and (C) the 3D blendshape model overlying the mesh output from the face tracker after the application of rigid transformations.

In step S104 affine transforms that maps the face model to the output of the tracker are computed.

FIG. 7 schematically illustrates correspondences between the points 710 of the template face model (A) and the sparse facial feature points 720 on the output mesh of the face tracker (B).

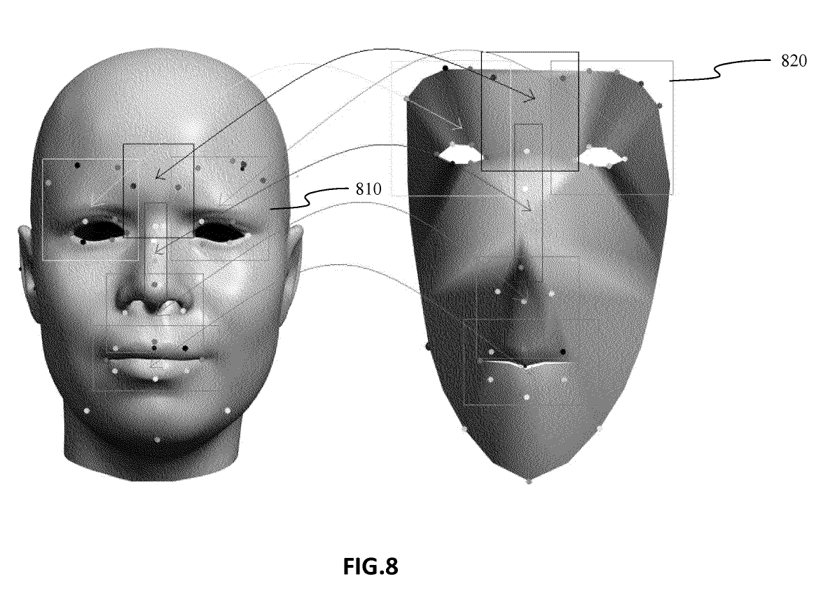

Facial feature points of the 3D face model are grouped into face regions 810, and the corresponding landmark points of the face tracker are grouped into corresponding regions 820 as shown in FIG. 8. For each region, a local affine warp Tᵢ is computed that maps a region from the face model to the corresponding region of the output of the face tracker. This local affine warp is composed of a global rigid transformation and scaling (that affects all the vertices) and a residual local affine transformation Lᵢ that accounts for localized variation on the face.

Tᵢ=LᵢG (5)

Where Lᵢ is a 4×4 matrix, for example, given by:

$${L}_{i} = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ 0 & 0 & 0 & 1\end{matrix} ]$$

and G may also be a 4×4 matrix given by:

$$G = [ \begin{matrix}sR & t \\ {0}^{T} & 1\end{matrix} ]$$

Where s is uniform scaling, R is a Rotation matric and t is the translation column vector.

Considering Y as a neutral mesh (mesh corresponding to a neutral expression) of the 3D face model and Z as the corresponding neutral mesh from the face tracker, for a particular i'th neighbourhood:

TᵢYᵢ=Zᵢ

where Yᵢ and Zᵢ are basically the 4×m and 4×n matrices with m and n as the number of vertices present in the ith neighbourhood of Y and Z respectively. Yᵢ and Zᵢ are both composed of the homogeneous coordinates of their respective vertices. The equation may also be written as:

LᵢJᵢ=Zᵢ

where Jᵢ is the ith neighbourhood of the neutral mesh of the 3D face model with a global rigid transform applied. Taking the transposition of the above equation on both sides:

Jᵢ^{T}Lᵢ^{T}=Zᵢ^{T}

which can be simplified as:

AX=B

where A=Jᵢ^{T}, X=Lᵢ^{T} and B=Zᵢ^{T}. To compute the localized affine transform Lᵢ^{T} for a particular i^{th} neighbourhood, a global rigid transform is applied to align Yᵢ with Zᵢ This is done by superimposing the mesh of the model and the mesh output from the facial tracker on top of one another and then computing the amount of scaling, rotation and translation in order to provide the alignment. This is given by matrix G to give

Jᵢ=GYᵢ

The solution of the underconstrained problem is given by:

X=A⁺B

where A⁺ is called the pseudo inverse of A for under determined problems and is given by:

A⁺=A^{T}(AA^{T})⁻¹

Finally the Local Affine transform matrix for the ith neighbourhood is given by Lᵢ=X^{T} With the localized affine transform Lᵢ, Tᵢ for the ith neighbourhood can be computed from equation 5.

For each corresponding neighbourhood an affine transform Ti that maps the ith neighbourhood of the neutral 3D face model Yᵢ to the ith neighbourhood of the neutral mesh Zᵢ from the face tracker.

The localized affine warps are used to translate 3D vertex displacements from one space to another

Further steps of the method involve computing the displacements of the landmark points in the frames of the video from the original landmark point locations in the neutral mesh Z.

In a particular embodiment, sparse 3D vertex displacements obtained from the facial landmark tracker can be projected onto the dense face model.

Indeed landmark points tracked in the face tracker for particular frame K of the video of captured images are used to build a 3D mesh Sₖ. Both Z and Sₖ are arranged in n×3 matrices where n is the number of landmark points present in the 3D point cloud generated as an output from the face tracker for each frame and the 3 columns are for the x, y and z coordinates for each vertex. Hence the n×3 displacement matrix for the 3D mesh from the face tracker which is composed of displacements occurring in each of the landmark points for a particular kth frame is given by

D_{K}^{S}=Sₖ−Z

Using the affine mapping previously computed and with the displacement matrix of the Kth frame of the output 3D point clouds from the face tracker, the displacements for corresponding points for the K^{th} frame of the 3D model can be inferred.

For a particular i^{th} neighbourhood and K^{th} frame the displacement matrix is given as:

D_{Ki}^{s}=Ti⁺D^{F}_{Ki} (6)

where Tᵢ⁺ denotes the pseudo-inverse of the affine warp Tᵢ, and D^{F}_{Ki} and D^{S}_{Ki} denote the 3D displacements in the space of the face model and the sparse landmark tracker respectively, for the i^{th} vertex in the region at the K^{th} time-step (frame). In this way, a set of sparse 3D vertex displacements is obtained as constraints for deforming the dense 3D face model F.

A process of direct manipulation blendshapes is performed (J. P. Lewis and K.-i. Anjyo. Direct manipulation blendshapes. IEEE Comput. Graph. Appl., 30(4):42-50, July 2010) for deforming the 3D facial blendshape model by taking the sparse vertex displacements as constraints. By stacking all the constraining vertices into a single column vector M, this can be written as a least-squares minimization problem as follows

Min_{w}_{_{c}}|Bw_{c}−M|²+α|w_{c}−w|² (7)

Where B is the matrix containing the blendshape targets for the constrained vertices as different columns, and α is a regularization parameter to keep the blending weights w_{c} close to the neutral expression (w).

With these blending weights the blendshape can be obtained for the K^{th} frame given by

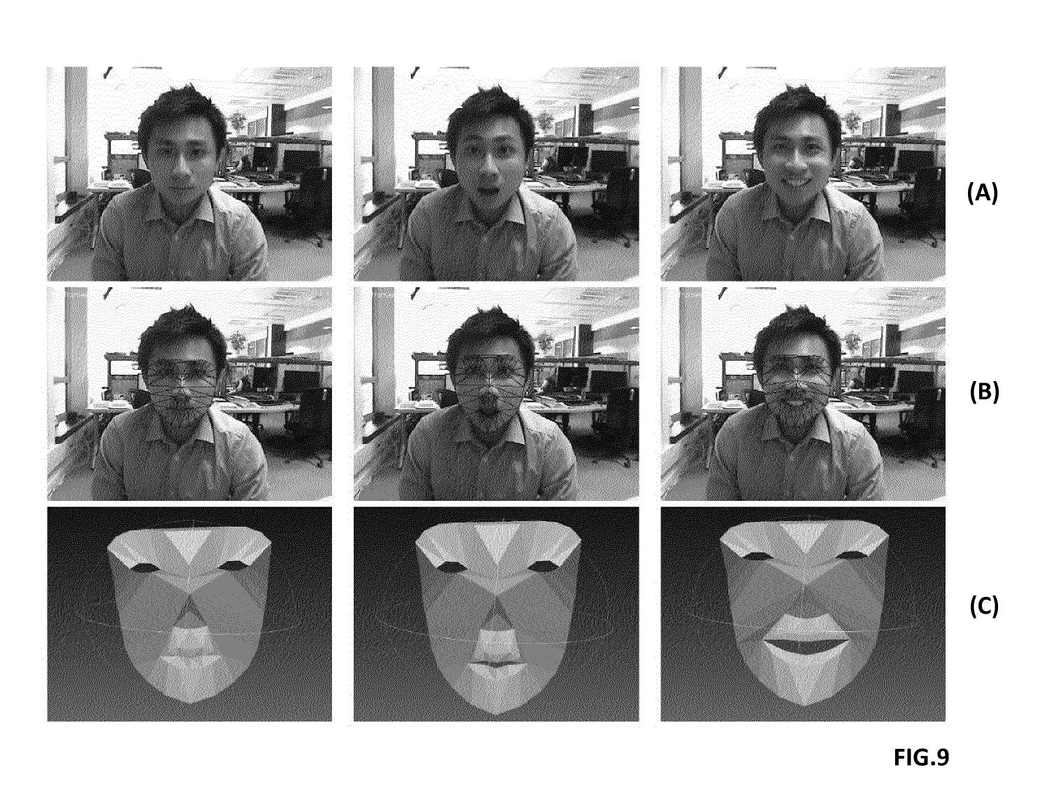

F_{K}=Bw_{K} (8)

Where w_{K}=w_{c} with the current frame being considered as the K^{th} frame. A sequence of tracked blendshape meshes for the captured video is thus obtained. An example of tracked models is illustrated in FIG. 9. The top row (A) presents captured images, the middle row (B) illustrates the overlay of the model on the detected facial landmarks and the bottom row (C) illustrates the geometry of the sparse set of feature points visualized as a 3D mesh.

The following step involves projecting the meshes onto the image frames in order to build up a correspondence between the pixels of the K^{th} frame and the vertices in the K^{th} 3D blendshape model.

For the Kth 3D blendshape and ith neighbourhood the affine transform can be given as

H_{Ki}=TᵢF_{Ki}

where H_{Ki} is the i^{th} neighbourhood region of the tracked 3D blendshape model for the Kth frame after transferring it to the face space of the face tracker.

The method deforms the entire dense 3D mesh predicting vertex displacements all over the shape. These vertex displacements can be projected back into the image space by accounting for the localized affine warp for each region. Applying the projection matrix for the Kth frame gives:

h_{Ki}=Pₖ(TᵢF_{Ki}) (9)

where h_{Ki} are the image pixel locations of the projected vertices in the i^{th} region at the K^{th} time-step, Pₖ is the camera projection matrix for the K^{th} time-step. Tᵢ is the affine warp corresponding to the i^{th} region. F_{Ki} is the deformed 3D shape of the facial blendshape model.

Step S105 involves registering the 3D face blendshape model to the previous output of sparse facial landmarks, where the person in the input video has very different physiological characteristics as compared to the mesh template model.

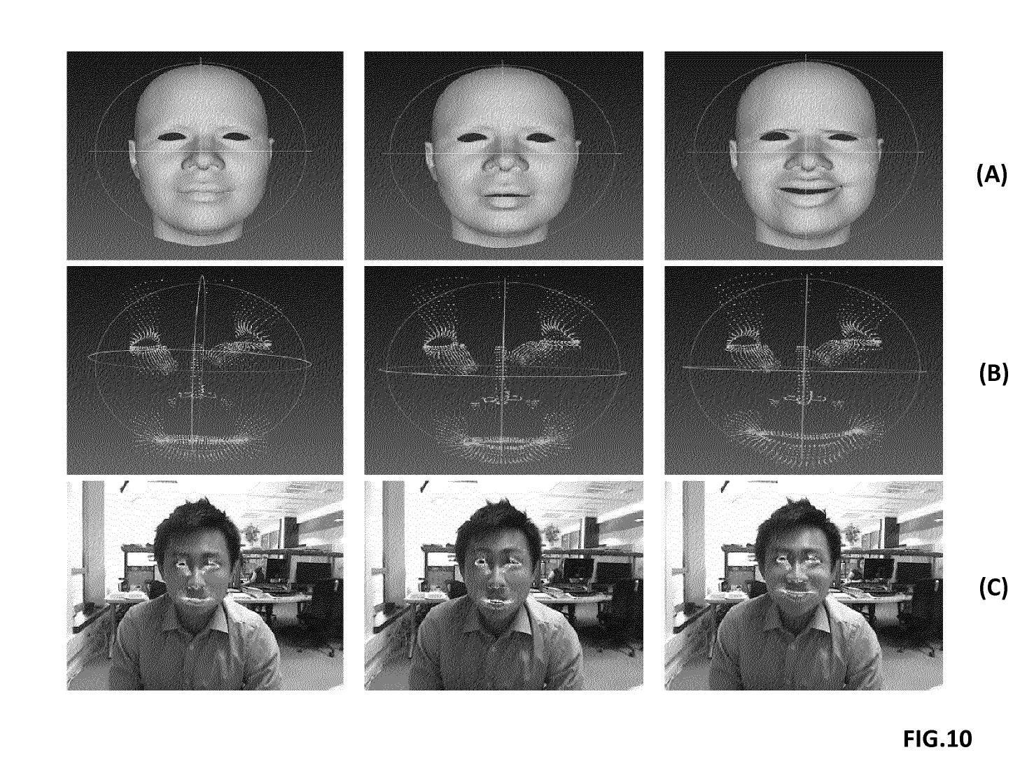

Using the technique of face registration by localized affine warps according to the embodiment of the invention, a dense registration of the different regions in the face model to a given input face image is obtained, as illustrated in FIG. 10. FIG. 10 the registered 3D face model to different face input images. The top row (A) shows the 3D mesh model with the registered facial expression, the middle row (B) shows the dense 3D vertices transferred after the affine warp, the bottom row (C) shows these dense vertices 3D aligned with the appropriate face regions of the actor's face In the images we can clearly see a dense point cloud for each neighbourhood region which can be projected onto the image to provide a dense correspondence map between the pixels of the images and the vertices of the model.

Apparatus compatible with embodiments of the invention may be implemented either solely by hardware, solely by software or by a combination of hardware and software. In terms of hardware for example dedicated hardware, may be used, such ASIC or FPGA or VLSI, respectively <<Application Specific Integrated Circuit>>, <<Field-Programmable Gate Array>>, <<Very Large Scale Integration>>, or by using several integrated electronic components embedded in a device or from a blend of hardware and software components.

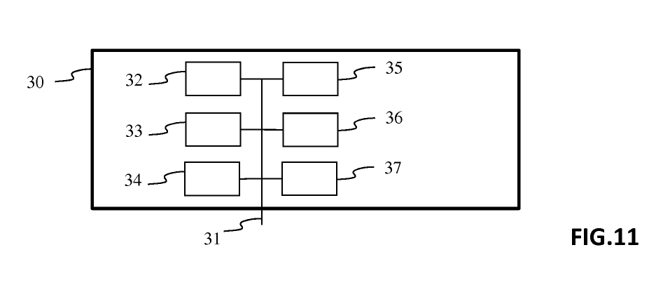

FIG. 11 is a schematic block diagram representing an example of an image processing device 30 in which one or more embodiments of the invention may be implemented. Device 30 comprises the following modules linked together by a data and address bus 31:
a microprocessor 32 (or CPU), which is, for example, a DSP (or Digital Signal Processor);
a ROM (or Read Only Memory) 33;
a RAM (or Random Access Memory) 34;
an I/O interface 35 for reception and transmission of data from applications of the device; and
a battery 36
a user interface 37

According to an alternative embodiment, the battery 36 may be external to the device. Each of these elements of FIG. 9 are well-known by those skilled in the art and consequently need not be described in further detail for an understanding of the invention. A register may correspond to area of small capacity (some bits) or to very large area (e.g. a whole program or large amount of received or decoded data) of any of the memories of the device. ROM 33 comprises at least a program and parameters. Algorithms of the methods according to embodiments of the invention are stored in the ROM 33. When switched on, the CPU 32 uploads the program in the RAM and executes the corresponding instructions to perform the methods.

RAM 34 comprises, in a register, the program executed by the CPU 32 and uploaded after switch on of the device 30, input data in a register, intermediate data in different states of the method in a register, and other variables used for the execution of the method in a register.

The user interface 37 is operable to receive user input for control of the image processing device.

Embodiments of the invention provide that produces a dense 3D mesh output, but which is computationally fast and has little overhead. Moreover embodiments of the invention do not require a 3D face database. Instead, it may use a 3D face model showing expression changes from one single person as a reference person, which is far easier to obtain.

Although the present invention has been described hereinabove with reference to specific embodiments, the present invention is not limited to the specific embodiments, and modifications will be apparent to a skilled person in the art which lie within the scope of the present invention.

For instance, while the foregoing examples have been described with respect to facial expressions, it will be appreciated that the invention may be applied to other facial aspects or the movement of other landmarks in images.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

1. A method of registering an image to a model, comprising:
providing a 3D facial model, said 3D facial model being parameterized from a plurality of facial expressions in images of a reference person;
tracking a set of facial landmarks in a sequence of facial images of a target person to provide sets of facial feature points defining the facial landmarks;
computing a set of localized affine transformations connecting facial regions of the said 3D facial model to corresponding sets of feature points defining the facial landmarks;
applying the set of localized affine transformations to the 3D facial model; and
registering the sequence of facial images of the target person with the transformed 3D facial model.

2. The method according to claim 1 wherein the 3D facial model is a blendshape model of a reference face parameterized to blend between different facial expressions.

3. The method according to claim 2 wherein the 3D blendshape model is parameterized into a plurality of sparse localized deformation components.

4. The method according to claim 2 wherein the blendshape model is a linear weighted sum of different blendshape targets representing sparse and spatially localized components of different facial expressions

5. The method according to claim 1 wherein a sparse spatial feature tracking algorithm is used to track the set of facial landmarks.

6. The method according to claim 5 wherein the sparse spatial feature tracking algorithm applies a point distribution model linearly modeling non-rigid shape variations around the facial landmarks.

7. The method according to claim 1 wherein each localized affine transformation is an affine warp comprising at least one of:
a global rigid transformation function;
a scaling function for scaling vertices of the 3D facial model; and
a residual local affine transformation that accounts for localized variation on the face.

8. The method according to claim 1 comprising registering the 3D facial model over the sets of facial feature points after applying at least one of a rigid transform and a non-rigid transform.

9. The method according to claim 1 comprising aligning and projecting dense 3D face points onto the appropriate face regions in an input face image of the target person.

10. A device for registering an image to a model, the device comprising memory and at least one processor in communication with the memory, the memory including instructions that when executed by the processor cause the device to perform operations including:
tracking a set of facial landmarks in a sequence of facial images of a target person to provide sets of feature points defining facial landmarks;
computing, a set of localized affine transformations connecting a set of facial regions of a 3D facial model to the sets of feature points defining sparse facial landmarks; and
applying the localized affine transformations to the 3D facial modem and
registering the sequence of facial images with the transformed 3D facial model.

11. A computer program product for a programmable apparatus, the computer program product comprising a sequence of instructions for implementing a method according to claim 1 when loaded into and executed by the programmable apparatus.
